(19) United States
(12) Patent Application Publication
(10) Pub. No.: US 2026/0355067 A1
(43) Pub. Date: Nov. 12, 2026

(54) AN INJECTION MOLDED TPE (THERMOPLASTIC ELASTOMER) NIPPLE OR PACIFIER AT SHORE 30 A TO SHORE 40 A

(71) Applicant: Niels Peter ESTRUP, Hinnerup (DK)

(72) Inventor: Niels Peter ESTRUP, Hinnerup (DK)

(21) Appl. No.: 19/515,485

(22) PCT Filed: Aug. 12, 2024
(86) PCT No.: PCT/DK2024/050188

§ 371 Date: Mar. 1, 2026

(30) Foreign Application Priority Data
Sep. 1, 2023 (DK) PA202330184

(51) Int. Cl. A61J 17/00

(52) U.S. Cl. CPC A61J 17/001; A61J 17/103; A61J 17/109; A61J 2205/20

(57) ABSTRACT

This injection molded TPE nipple or pacifier at shore 30 A to 40 A is the alternative to nature rubber and silicone pacifiers. This pacifier material is not vulcanized, without harmful materials like nitrosamines and formaldehyde. For the first time a pacifier can be reused.

This invention has all the needed qualifications to be a real alternative to known pacifiers/nipples.

The TPE blend we have made of can do the same as the latex, rubber, and silicone pacifiers.

We have the perfect combination of tear Strength and tensile Strength provides bite-resistance and still get the nipple/pacifier down to Shore 40 A. We have a tested blend where the Shore are at 37.5 A is the blend is passing the tests, towards tearing and biting.

Contributes to weight reduction of the pacifier and nipple in general since TPS (thermoplastic elastomers based on Styrenic-block-copolymers) is lighter.

### FIELD OF THE INVENTION

The present invention relates to a nipple/pacifier made of recyclable TPE of thermoplastic elastomers based on Styrenic-block-copolymers, still strong and safe and soft enough for pacifier use. Normal pacifiers will be used over a long period of time during the day, when the child is from 0-3 years. That's why the Shore of the material are of great importance if the product should not harm the child. The reason this nipple/pacifier was invented was the knowledge of the chemical-containing vulcanization process making all latex rubber and silicone especially for pacifiers/nipples for children. Latex, silicone, and rubber normally have grades of shores around shore 40 A and that's what we have been aiming for a very low shore at 30-40 A and still retain all the properties necessary for a pacifier usage. All naturel rubber, naturel latex, rubber, or silicone is vulcanized.

Silicone and rubber material have a high application value after vulcanization, the mechanical properties are greatly improved, with no sticky, not easy to break, elasticity, high temperature resistance, tensile strength, insoluble in water in organic solvents and other characteristics.

Natural rubber, natural latex and synthetic silicone rubber is required to use vulcanizing agent to vulcanize.

Silicone rubber vulcanization is divided into two stages: the first stage is divided into raw rubber, reinforcing agent, additives, vulcanizing agent and structural control agent for raw material mixing, to get the raw material of silicone and rubber, the raw material will be deployed as a semi-formed material; the second stage in the material and finished material into the hardware molding in the thermal molding, extrusion, extrusion, injection and other processes, to machine stress and product catalytic solid words, molding after high temperature molding. Here we mention some of the well-known accelerator's agents used in the process of vulcanization still used in 2023.

The applicant (D1) WO 97/49352 A1 (GILLETTE CANADA) 31 Dec. 1997 is mentioning a material at shore 37 A of TPE, but the application is about DENTAL FLOSS WITH THERMOPLASTIC COATING, which does not as strong as the pacifier needs to be. The pacifier TPE must pass the EN1400 standard (see Background of this invention I 27-30) where bite and tear strength are tested and a floss coating can not pass this test.

Another applicant (D2) WO 2005/087867 A1 (GLS CORP) 22 Sep. 2005 is describing BLOCK COPOLYMER COMPOSITIONS FOR OVERMOLDING ANY NYLON, but again not anything to do with the popuse like a pacifier/nipple, where the bite and tear resistance are very important and must be passed in the test regarding the standards EN EN1400:2013+A2:2018.

D3 is a company selling TPE materials—RTP Company: Product Data Sheet & General Processing Conditions RTP 2700 S-30A

Again, this is not a pacifier/nipple material usage, since this TPE cannot pass the EN1400 standard for pacifiers.

### Trade Names of Vulcanizing Agents Still Used in the Industry of Vulcanization

Magnesium Oxide and Zinc Oxide=(Exposure to Magnesium Oxide can cause “metal fume fever.” This is a flu-like illness with symptoms of metallic taste in the mouth, headache, fever and chills, aches, chest tightness and cough. Zinc oxide can cause symptoms if it is eaten, or if its fumes are breathed in. Local skin irritation and allergic reactions may occur if you are sensitive to the chemical)

Hexamethylene Diamine=(Hexamethylene Diamine is a CORROSIVE CHEMICAL and contact can severely irritate and burn the skin and eyes with possible eye damage. *Breathing Hexamethylene Diamine can irritate the nose, throat and lungs causing tightness in the chest and/or difficulty in breathing)

Metal Oxides Proprietary=(Almost all metal oxide nanoparticles used in commercial applications are generally thought of as safe at low concentrations, as there is no overwhelming evidence to the contrary)

t-Butyl Perbenzoate=(Danger! According to the classification provided by companies to ECHA in REACH registrations this substance is very toxic to aquatic life, is harmful if inhaled, is harmful to aquatic life with long lasting effects, if heated may cause a fire, causes skin irritation and may cause an allergic skin reaction)

Dicurnyl Peroxide=(Hydrogen peroxide is an oxidizing chemical found in many households and industrial settings. It is generally safe at household concentrations (usually about 3%) but can be dangerous if used inappropriately. Industrial concentrations (usually up to 70%) can cause significant mortality and mortality)

Calcium Carbonate, (Calcium carbonate is the active ingredient in agricultural lime and is created when calcium ions in hard water react with carbonate ions to create limescale. It has medical use as a calcium supplement or as an antacid, but excessive consumption can be hazardous and cause hypercalcemia and digestive issues.)

Silica=(As it is 100 times smaller than a grain of sand, you can be breathing it in without knowing. Exposure to silica dust can lead to the development of lung cancer, silicosis (an irreversible scarring and stiffening of the lungs), kidney disease and chronic obstructive pulmonary disease.)

tButyl Peroxymaleic=(Exposure can cause headache, dizziness, drowsiness, confusion and passing out. a DANGEROUS FIRE HAZARD. OSHA: The legal airborne permissible exposure limit (PEL) is 100 ppm averaged over an 8-hour workshift.

tButylperoxy=(The single-dose systemic toxicity of tert-butanol is low, but it is irritant to skin and eyes; high oral doses produce ataxia and hypoactivity and repeated exposure can induce dependence.)

Sulfur=(Sulfur is low in toxicity to people. However, ingesting too much sulfur may cause a burning sensation or diarrhea. Breathing in sulfur dust can irritate the airways or cause coughing.)

N-Oxydiediylenebenz othiazole-2-Sulfenamide=(The well-established toxicity associated with thioamides and thioureas has led to the speculation that thiazole toxicity is attributed to ring scission yielding the corresponding thioamide metabolite [174]. Ring opening has also been observed in benzothiazoles. (Insoluble Sulfur Oil treated.)

Dibenzoyl p-Quinonedioxime=(Repeated eye exposure can cause brown staining and/or a deformed cornea and reduced vision. *p-Benzoquinone can irritate the lungs. Repeated exposure may cause bronchitis to develop with cough, phlegm, and/or shortness of breath. *p-Benzoquinone may affect the kidneys)

Hexamethylenediamine Carbamate=(Hexamethylene Diamine is a CORROSIVE CHEMICAL and contact can severely irritate and burn the skin and eyes with possible eye damage. *Breathing Hexamethylene Diamine can irritate the nose, throat and lungs causing tightness in the chest and/or difficulty in breathing.)

Dicinnamylidene=(However, N,N′-Dicinnamylidene-1,6-hexanediamine may also have potential toxic effects on cells and tissues. Studies have shown that N,N′-Dicinnamylidene-1,6-hexanediamine can induce oxidative stress and DNA damage in cells, which may lead to cell death and tissue damage. Therefore, further studies are needed to determine the potential therapeutic and toxic effects of N,N′-Dicinnamylidene-1,6-hexanediamine.

1,6-Hexanediamine, Lead Oxides=(Acute toxicity—Category 4; H302 (Harmful if swallowed) Acute toxicity—Category 4; H312 (Harmful in contact with skin) Specific target organ toxicity (single exposure)—Category 3; H335 (May cause respiratory irritation) Skin corrosion—Category 1B; H314 (Causes severe skin burns and eye damage).

The industry of pacifiers has produced pacifiers' nipples for more than 130 year and are still using vulcanized latex, rubber, and silicone and in the pacifier legal standard EN1400:2013+A2:2018 the used as a standard for pacifiers it also written that the two materials rubber and silicone leave traces of certain chemicals like (see below).
FORMALDEHYDE
N-NITROSAMINERS
N-NITROSATATABLES
MERCAPTOPTOBENZOTHIAZOLE RELEASE
ANTIOXIDANTS RELEASE
VOLATILE COMPOUND CONTENT

These are chemicals allowed in a pacifier in year 2023, as long the pacifiers material and the nipples made of rubber, Latex and silicone are below a certain level of these well documented harmful chemicals, then it is OK. It's allowed to vulcanize and indirectly put the harmful material as the mentioned into the mouth of a baby.

If asked under oath: “Is there formaldehyde and nitrosamines in this rubber and silicone or Latex pacifier”?

Saying NO—you would tell a lie!

Our goal is to change that by using a better material like TPE=not vulcanized, meaning without all mentioned chemicals and still just as good as the know pacifiers of the last 130 years.

However, pacifiers made of thermoplastic elastomer (TPE) has always had a big challenge to make it soft enough to compare it to silicone and latex rubber, temperature stability, moldability, tear strength, and tensile strength. This is properly the reason for not changing the latex, rubber, and silicone yet.

We have worked with TPE for more than 16 years and due that period TPE's (TPS) have changed dramatically. Now we see better TPS (TPE) material, stronger and better and now also soft enough, so we can use it as a nipple/pacifier.

In the sex-toy industry, TPE is also challenging silicone and rubber, latex, since the production costs of TPE is lower and the material is 100% recyclable. Rubber and silicone cannot be recycled.

We have tried again and again to make the right blend of TPE for this purpose as a nipple/pacifier challenging silicone and rubber on all levels.

We have made a lot of prototypes and kept on testing. Now we have the first nipple/pacifier soft and strong enough to be used as a pacifier/nipple daily, not just a onetime use pacifier, no as a real pacifier for babies/children from the age group from 0-4 years or when not needing the pacifier anymore. It is bite safe and nice and soft.

This new TPE injection molded nipple or pacifier at shore 30 A to Shore 40 A is doing the job.

We have tested TPS (TPE) from Shore A 30-45 and we found that a pacifier harder than Shore 40 A will not pass to be used as a pacifier, it will simply be too hard for the children and may have side effects, like increase fatigue in and around the mouth and make it difficult for the teeth to erupt naturally and if prolonged use it can damage and/or give sore mouth muscles, headaches the if the pacifier is harder than 40 A.

Our TPE is tested in real life and with a real nipple/pacifier design. A pacifier must be Shore 40 A or lower-above Shore 40 A it will not be used for a pacifier since it is too hard for a baby or child to keep in the mouth over a longer period. The material must be as natural as possible and a real breast/nipple will be close to Shore 40 A and lower, so having a pacifier harder than Shore 40 A makes no sense, since it will not work for a pacifier purpose.

The application WO2009009372A1—

TPE COMPOSITION HAVING GOOD CLARITY AND LOW HARDNESS AND ARTICLES FORMED THEREFROM.

WO2009009372A1 describes all the benefits about TPE compared to silicone. The invention mentioning several places in the allocation that they have managed to make a TPE, that solves, low hardness while also maintaining excellent clarity, low haze, temperature stability, moldability, tear strength, and tensile strength.

The WO2009009372A1 numerously mention low hardness and lower than Shore 45 A, but how low is it?

The applicant mentioning “HAVING GOOD CLARITY” in their invention and that feature in not our priority.

In the description WO2009009372A1 point 0009, 0010, 0014, 0015 the applicant talks about a shore A 45 or below that. If the WO2009009372A1 applicant had been at 40 A or lower their surely would have mentioned it since this has been one of the TPE's weaknesses compared to silicone in the past.

In point 0012 WO2009009372A1 is says.

“Accordingly, it would be desirable to have a TPE composition which has a hardness below 45 Shore A, while still maintaining the desired levels of clarity, haze, temperature stability, moldability, tear strength, and tensile strength”

If it is just below shore A 45 it would not be useable for a pacifier/nipple purpose. It might work for a bottle teat and for biting items like they describe in the application, but for a pacifier/nipple you must get at least down to shore 40 A or lower, just like we do in our invention using our blend of TPE made of Thermoplastic elastomers based on Styrenic-block-copolymers.

The applicant WO2009009372A1 describes in 0014 an item of 1.7 mm and 3.5 mm thickness tested. This indicates that the invention of WO2009009372A1 is not taking a pacifier design into consideration when testing, since a pacifier and a pacifier nipple design is no more than 1-1.5 mm thick since the child cannot use a thicker material to suck on, it would not work. It might work for a bottle teat and as a biting product for children, when it is in use only for a short time, but a pacifier is another issue.

In point 0033 describes Wo2009009372A1 tests of plagues. This surely shows that the applicant has tested only on plagues and not on a real product, (pacifier) where the hardness of the pacifier is crucial. Also, the applicant is focused on the clarity of the TPE, and this feature of course interrupt the softness, since the additives you add into the blend of the TPE to get the clarity will also take away some softness. In our invention softness if more important, than a see-through nipple/pacifier materiel.

The invention the applicant is describing is not suitable for pacifier use, since it is not soft enough.

We have developed a TPE material for a pacifier at Shore A 30-40 and this works for babies—not Shore 45 A. The TPE must be Shore 40 A or lower, but not above. We have tested our TPE for a period and the user of a pacifier can easily tell the difference between Shore 40 A and 45 A.

There is also a big difference between testing on a plague and on a real pacifier. The nipple of this TPE pacifier we are describing in our application is only 1-1.5 mm thick. This is why we have an invention and a new TPE blend that can deliver all required demands for pacifier use—ok clarity not 100% clear but milky and later maybe we can develop a clear TPE as well but now we have reached, temperature stability, moldability, tear strength, and tensile strength and it is bite prove.

A pacifier manufacturer of today normally buy silicone or latex, rubber nipples from an external manufacturer. If the manufacturer makes the shield and the grip in house, where to get a nipple part made of TPE?

Our blend of TPE have now passed internally that test and we can deliver this new TPE nipple and TPE pacifier at Shore 40 A and that is not possible today.

Applicant US 2004/0220323 A1 on page 1 003, 004 and 005 mentioning an invention. The invention is about making a see-through silicone like bottle teat.

Page 1—002 “The goal is to Substitute a thermoplastic, injection-moldable copolymer for the Silicone while providing essentially the same physical properties as those of the targeted Silicone”

Page 1 003 “A silicone having the aforesaid desired properties is used in premium mouthable articles because a Silicone can be formulated with the desired physical properties and also be Substantially transparent. Being able to see through a nipple body makes it easy for a caregiver to determine that the nipple body appears to be clean, and, when in use to feed an infant, to determine whether the infant is drawing liquid through the nipple or teat . . . ”

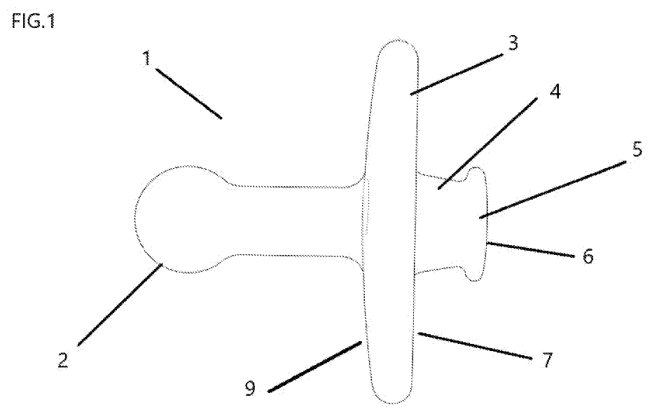

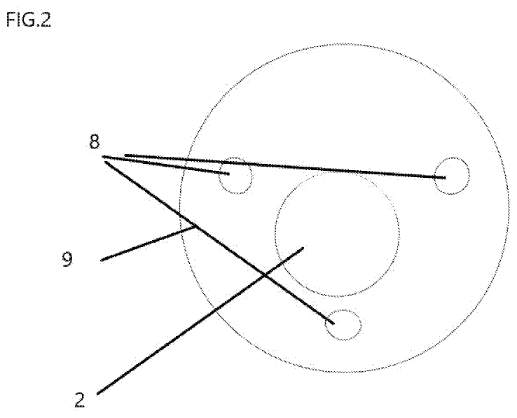

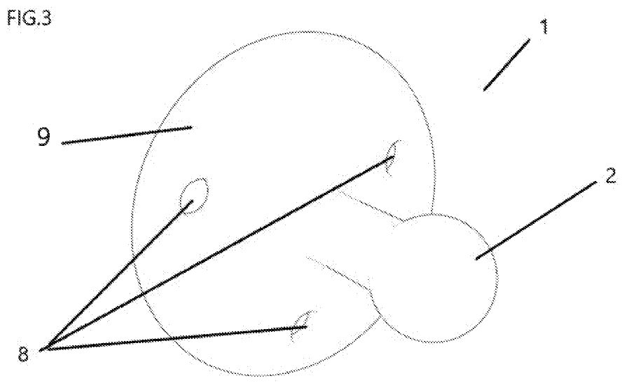

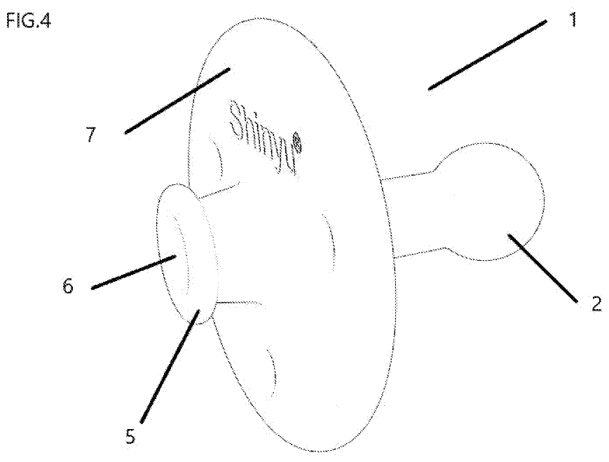

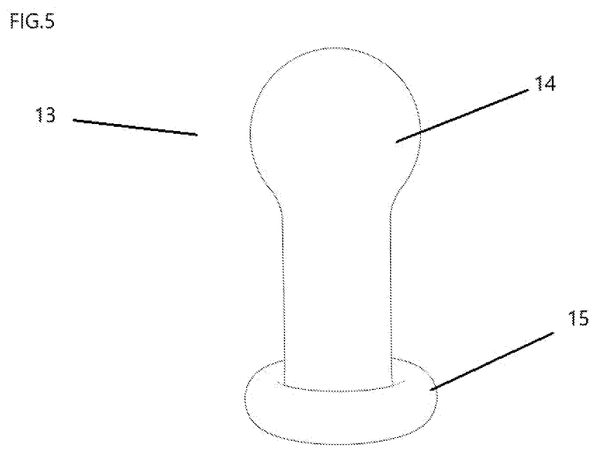

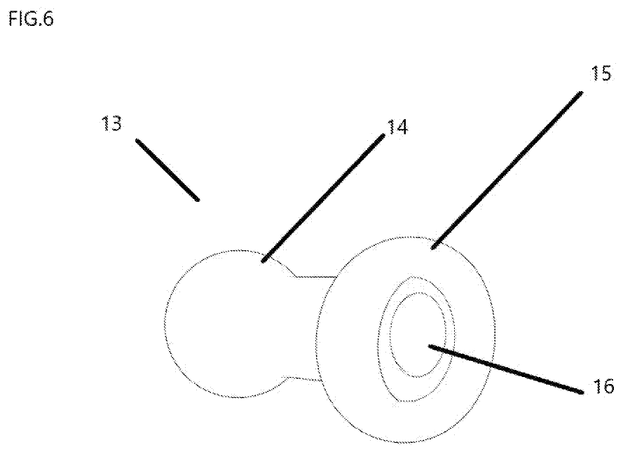

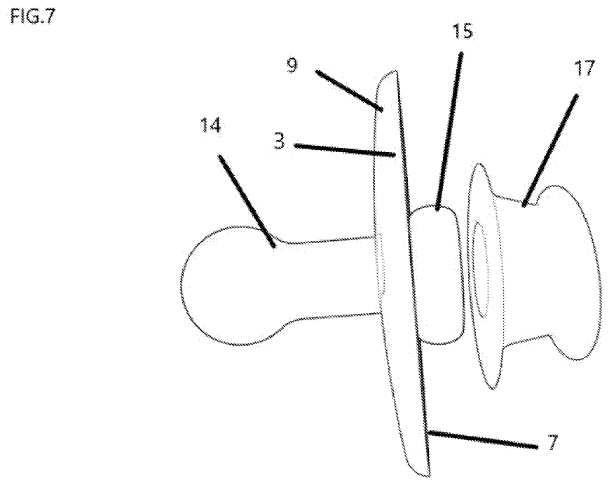

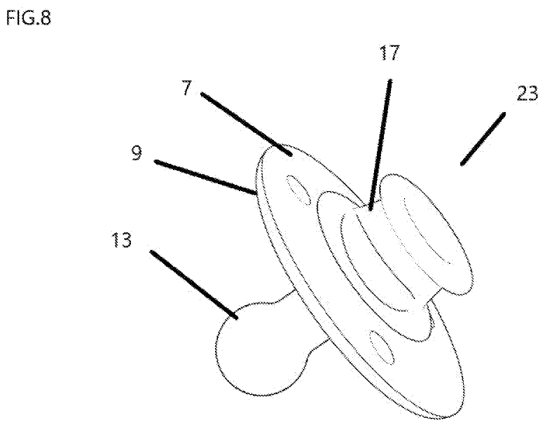

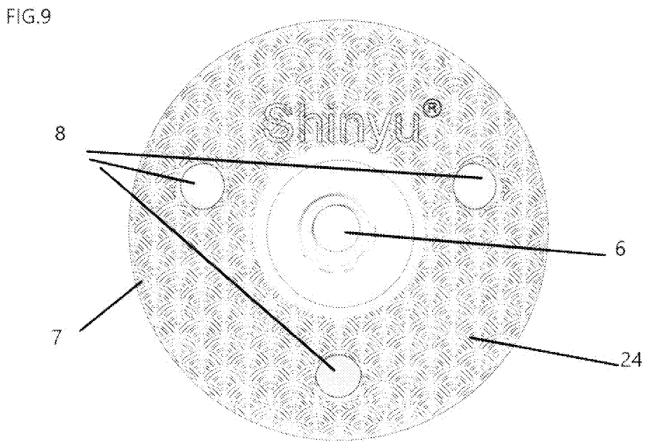

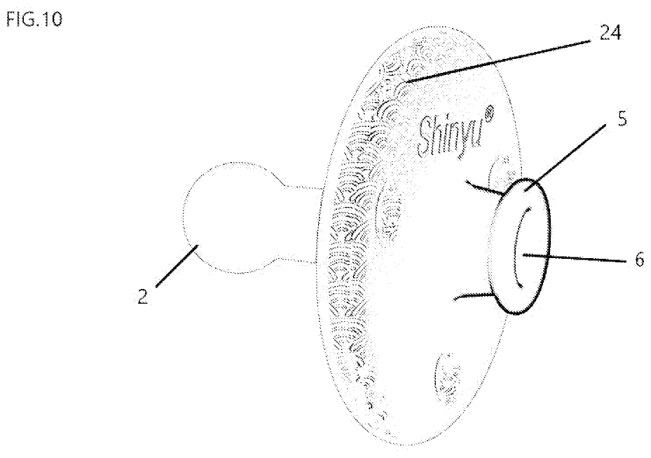

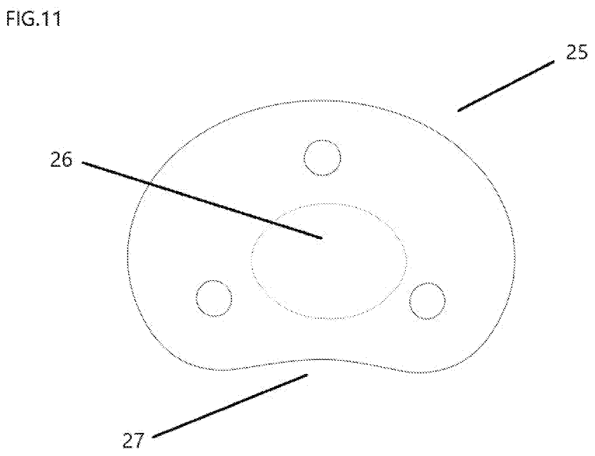

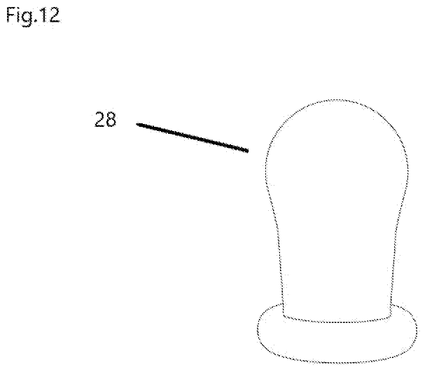

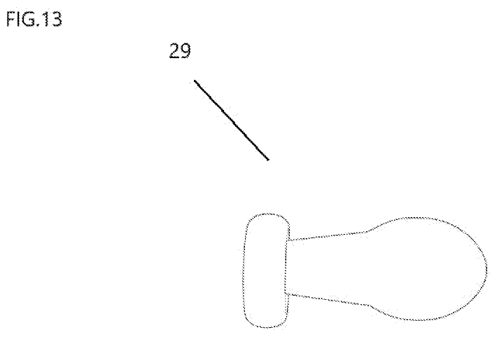

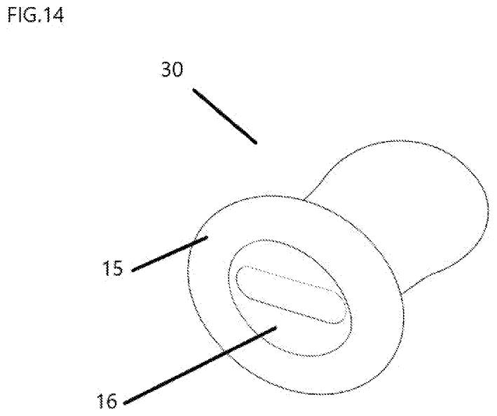

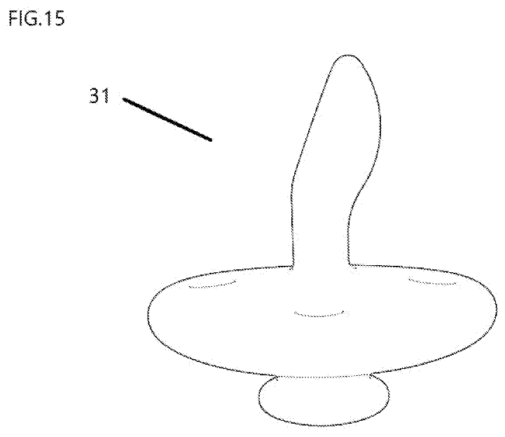

When looking at FIG. 1 and FIG. 2 of this application the drawings it is showing a teat for bottles and this teat should be made as see-through as possible as close to silicone as possible.

Page 1 003; “The desired properties of a typical “nipple grade’ Silicone are as follows: tensile strength near 6.9 MPa (1000 psi); tear resistance near 35 N/mm (200 lb/in); heat resistance to withstand sterilization temperatures near 100 °C without losing dimensional Stability; hardness no greater than Shore A 65; and lack of Substantial haze to provide “see-through” clarity So as to provide Visual indication of cleanliness. Though haze and clarity are measured differently, only haZe is measured herein, on the basis that Substantial lack of haze, less than 20%, provides a Substantially transparent injection molded material. The combination of tear Strength and tensile Strength provides bite-resistance.”

The applicant US 2004/0220323 A1 is telling about a teat for a bottle for feeding and not a pacifier since the shore for a pacifier should be no harder than Shore 40 A and when trying to make a transparent TPE they have to add vinyl and/or PP—at page 1—005 and oo6 it is mentioned how to add PP and/or vinyl into the TPE blend to make is strong enough and to make it transparent.

The material they are showing and describing is perfect as an alternative for teats for bottles compared to silicone, but for a pacifier it will be too hard at Shore A 55 as they describe, so they can see and check if the teat nipple is clean and if the baby is eating.

0019 talking about feeding.

“provides properties mimicking those of a Soft, tough, transparent Silicone Such as is used in a nipple for feeding an infant”

“designed to be mouthable by an infant, or in medical tubing and related articles which, in use, come in contact with body fluids”

It makes sense when the applicant US 2004/0220323 A1 describes a nipple for a bottle feeding a baby. Also, when used as a biting ring.

Bottle teats and biting rings are fine to be used by Shore A 45-55. The applicant is describing their invention to be transparent and when wanting the material to be transparent it is hard to get lower than Shore A 45, just like they are describing at the table 1 on page 7.

The applicant US 2004/0220323 A1, does not describe the invention as a pacifier not even the drawings are showing a single nipple for assembly usage for a normal pacifier made with PP shield and handle.

We have injected molded several 100% TPE pacifiers made of thermoplastic elastomers based on Styrenic-block-copolymers in our own test tools.

The test showed clearly that Shore 40 A is the top range at the Shore bar. It will not be work properly as a pacifier if harder than Shore 40 A. Compared to silicone and latex rubber and the child will not use a TPE nipple/pacifier if harder than Shore 40 A. That's the reason we are making nipples/pacifiers in Shore A 30 to Shore 40 A only and this is a novelty.

We offer other manufacturers of silicone and latex, rubber pacifiers to get the single nipple made of our TPE blend and they can still use the same manufacturing facilities where they normally assemble their pacifiers, by assembling a silicone/Latex, rubber nipple into a shield and close it with a lock on the back of the shield, now they just change the nipple part to this new TPE nipple Shore 40 A or lower than 40 Shore A.

An TPE injection molded nipple or pacifier we have developed is made of TPE. HSBC elastomers and are useful for many types of application; the choice of using SEBS, SEPS or SEEPS depends on the formulator and the final characteristics to be obtained.

The HSBC types were developed from SBCs, which have undergone a hydrogenation process that eliminates almost all unsaturation; for this reason, they are much more resistant than SBCs, and can be divided into SEBS, SEPS or SEEPS.

The elastomers we use are all Styrenic Block Copolymers because they are all based on Styrene and they have a “block” structure and in particular our elastomers have three “blocks”, the first and the last made by styrene, and the central one, according to the chemical nature of the monomer, may be:
B=Butadiene
I=isoprene (that provides vinyl groups, but they are unsaturated)
E=ethylene

Even our TPE is as soft as Shore 30-40 A we still can etch a pattern into the tools of the product like pacifier/nipple and the material reveals different visuals effects on a shield or on the nipple of a pacifier.

1. A nipple (13) or pacifier with a nipple (1), formed of TPE (thermoplastic elastomer) based on styrenic block copolymer, characterized in that the TPE has a shore hardness A between 30 to 40, wherein the nipple (13) comprises either: a) a nipple tip (14) and a nipple rim lock (15) at the foot of the nipple (13) configured to fit into a shield (3) and be locked into place by a grip (4) and lock (17) over a hole (16) on the back of the nipple (13); or b) a one-piece construction where the nipple (2), shield (3), and a rim grip (5) on the back of the shield (7) are all made of TPE; further characterized in that the TPE varies in thickness, with the nipple material part (2, 13) being the thinnest part in a range from 0.5 mm to 1.5 mm, and the shield (3) and grip (4) being thicker than the nipple material (2).

2. A nipple or pacifier according to claim 1, comprising a color-changing TPE material in the nipple (2, 13) and/or shield/grip (3, 4, 5), wherein the material changes color when the temperature in the mouth of a user is higher than 37 degrees Celsius to indicate a fever.

3. A nipple or pacifier according to claim 1, comprising a night-glowing fluorescent material making the dark pacifier or nipple visible in the dark.

4. A nipple or pacifier according to claim 1, comprising a pattern etched into the surface of the shield material (7).
